(19) United States
(12) Patent Application Publication
(10) Pub. No.: US 2007/0262492 A1
(43) Pub. Date: Nov. 15, 2007

(54) Acrylic piece and finishing method

(75) Inventor: Stephen Leo, Freeport, NY (US)

Correspondence Address: FRISHAUF, HOLTZ, GOODMAN & CHICK, PC, 220 Fifth Avenue, 16TH Floor, NEW YORK, NY, 10001-7708, US

(73) Assignee: RETAIL SOLUTIONS CENTER, INC., Freeport, NY (US)

(21) Appl. No.: 11/430,790

(22) Filed: May 9, 2006

(51) Int. Cl. B29C 71/00

(52) U.S. Cl. 264/345; 264/340

(57) ABSTRACT

Method for finishing a machined and cut acrylic piece to eliminate porosity of the cut and machined surfaces includes exposing all sides of the piece, then inserting the exposed piece into a heated oven, keeping the piece in the oven while the oven is maintained at a set temperature or within a set temperature range, and then removing the piece from the oven after the predetermined period of time. After this beating cycle, the machined and cut surfaces are non-stressed and therefore the acrylic piece is resistant to forming striations even when the cut and machined surfaces are exposed to oil and chemicals which cause striations in machined and cut surfaces of non-treated acrylic pieces. The predetermined period of time for heating the piece depends on a thickness of the piece and on whether the temperature in the oven environment is measured and controlled.

### FIELD OF THE INVENTION

The present invention relates generally to a method for finishing acrylic pieces and more particularly to a method for finishing acrylic pieces in order to remove striations in any cut, routed, or machined areas which arise during manufacture.

### BACKGROUND OF THE INVENTION

Acrylic is frequently used in retail displays in the form of planar blocks or pieces having, for example, a rectangular shape. Items to be displayed are set into indentations or channels formed in the acrylic pieces. Acrylic retail displays are typically found in the cosmetic department of a retail establishment. The acrylic is cut and machined to the proper configuration of the display.

One particular problem with acrylic pieces manufactured according to current production methods is that the cut or machined areas of the piece become stressed and susceptible to damage from alcohol-based chemicals. When an alcohol-based chemical from a person's skin and/or the cosmetics come in contact with the cut or machined areas of the acrylic pieces of the retail display, irregularities which are visible to the naked eye, namely striations or cracks, form. Over a period of time of exposure to the alcohol-based chemicals the striations and cracks can extend entirely through the acrylic piece. These striations appear as a series of internal scratch marks which are not felt but are only seen or as full cracks. This greatly affects the aesthetic appearance of the display to the consumer. It would be desirable to eliminate the striations on the sides of acrylic pieces and thereby provide more aesthetically pleasing acrylic pieces.

### OBJECTS AND SUMMARY OF THE INVENTION

It is an object of the present invention to provide a new method for finishing acrylic pieces in order to eliminate the possibility of striations forming on their sides and machined areas.

It is another object of the present invention to provide a new method for finishing acrylic pieces to a condition in which striations will not form so that the acrylic is more aesthetically pleasing than currently existing acrylic pieces.

In order to achieve these objects and others, a method for finishing an acrylic piece in accordance with the invention to eliminate the formation of striations in its sides includes exposing all sides of the acrylic piece, inserting the exposed acrylic piece into a heated oven, keeping the acrylic piece in the oven while the oven is maintained at a set temperature or within a set temperature range, and then removing the piece from the oven after the predetermined period of time. After this heating cycle, the machined and cut portions of the acrylic piece will be sealed so that cut and machined areas are no longer stressed and striations or other irregularities will not form when exposed to alcohol-based chemicals present on the human skin, cosmetics, and other chemicals.

An aspect of the invention is determining a sufficient amount of time for heating the machined and cut acrylic piece in the oven, i.e., to ensure the piece is subject to a sufficient amount of thermal energy. It is has been discovered that the predetermined period of time for heating the piece depends significantly on a thickness of the piece whereby for batches having different thickness but using the same oven temperature or temperature range, the predetermined period of time is greater for the thicker pieces.

The predetermined period of time also depends on whether the temperature in the oven environment is measured and controlled based thereon to ensure that it remains at a set temperature or within a set temperature range. If the oven temperature is measured, there is a set time duration for each different thickness piece which will ensure that the piece will be subject to sufficient thermal energy to cause the cut and machined portions to become non-stressed so as to eliminate the possibility of the formation of striations. On the other hand, when the temperature is not measured continuously throughout the heating stage, an additional period of time is added to the set time duration, which additional period of time is based on the thickness of the piece. This is necessary to account for a situation where the temperature may have fallen below the set temperature or below the lowest temperature of the set temperature range.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a flow chart of a method for finishing acrylic pieces in accordance with the invention.

FIG. 2 is a table setting forth heating durations for acrylic pieces finished by a method in accordance with the invention.

### DETAILED DESCRIPTION OF THE INVENTION

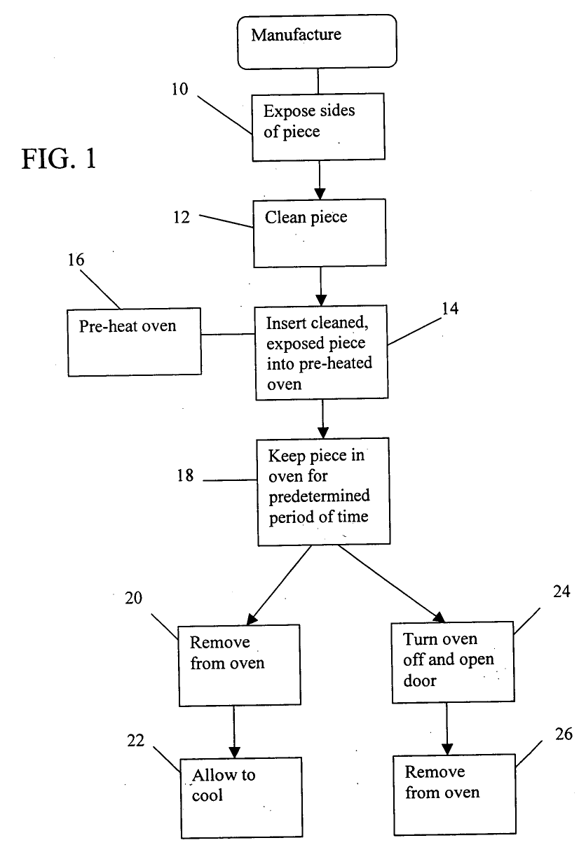

Referring to the accompanying drawings wherein like reference numbers refer to the same or similar objects, FIG. 1 is a flow chart of a method in accordance with the invention for finishing acrylic pieces after their formation and manufacture. Regardless of the manufacturing process, machined and cut portions of acrylic pieces are stressed and susceptible to the formation of irregularities when exposed to alcohol-based chemicals. These irregularities appear, for example, as striations internally within the acrylic piece or as cracks. Although the sides of the acrylic pieces can be smooth, the striations are visible to the naked eye. Finishing the machined and cut acrylic pieces by a method in accordance with the invention eliminates the stressing caused by the cutting and machining of the surfaces and prevents the formation of striations or cracks.

After the acrylic piece is machined and cut to the desired proportions, the first step 10 in the method is to expose all sides of the pieces which, for example, involves removing from the pieces, protective film or paper. Such film or paper is typically present on one or more sides of the pieces during manufacture to prevent the acrylic from marring during processing.

After the sides of the pieces are exposed, an optional but preferred step 12 is to clean the exposed sides of the pieces. This may entail directing a stream of clean air at each piece. The air stream or piece may be moved relative to one another to ensure that the air stream impacts all exposed areas of the piece.

Once all portions of the piece are exposed and preferably cleaned, in the preferred embodiment the next step 14 is to insert the pieces into an oven or other heatable, enclosed structure or environment having a regulateable temperature or temperature range and an access door. Preferably, an electrically heated oven with forced air circulation is used. The oven is pre-heated in step 16 to a set temperature, for example, about 170° F.

The manner in which the pieces are placed into the oven varies depending on the construction of the oven. If the oven is capable of receiving one or more removable racks extending across its width and vertically spaced from one another, then the pieces can be arranged in a desired formation on the racks when out of the oven and then the racks are placed into the oven. Preferably, when placing the pieces on each rack, care is taken to ensure that each piece is not in contact with any other piece as contact between the pieces can adversely affect the finishing method. Thus, the pieces are not stacked one on top of the other. Instead of placing the pieces directly on racks, or when the racks cannot support the pieces, the pieces can be placed on any flat substrate, such as a cookie sheet and the like, and then the flat substrate placed on a rack or shelf in the oven. Such racks or shelves are ideally adjustable, to avoid having vertical layers of pieces too close to one another which would hinder full air flow over and around the pieces, and also provide adequate support to prevent the cookie sheets from sagging.

Once the pieces are in the oven, they are kept therein while the oven is maintained at the set temperature for a predetermined period of time, step 18. This predetermined period of time typically starts only after the temperature in the oven has reached or recovered to the set temperature.

The temperature in the oven is preferably controlled during the predetermined time in order to maintain the oven at a set temperature which has been found to enable modification of the acrylic to eliminate the stressing of the cut and machined surfaces while ensuring the acrylic maintains its form. This temperature is about 170° F. At a significantly higher temperature, although the stressing may be eliminated, the acrylic pieces may lose their manufactured form whereas at a significantly lower temperature, the striations would not be removed.

Instead of maintaining the oven at a single, set temperature, the temperature of the oven can be maintained within a set temperature range (about 160° F. to about 180° F.) or within a range of a desired temperature, e.g., +/−110° F. of the desired temperature. Control of the temperature in the oven can involve measuring the temperature in the oven and adjusting the heating element(s) of the oven based on the measured temperature.

The period of time during which the pieces are kept in the oven is determined based in part on the thickness of the pieces. For thicker pieces, the period of time is greater than for thinner pieces, with the oven being at the same temperature. At a minimum, the pieces should be heated for at least two hours.

Another factor which influences the period of time the pieces are kept in the oven is whether the temperature in the oven is measured in order to ensure that it is maintained at the set temperature or within the set temperature range. The reason is because it is desired that the pieces be subject to a sufficient amount of thermal energy in order to eliminate the stressing of the cut and machined surfaces. If the temperature in the oven is measured and controlled to the set temperature or temperature range, it can be ensured that the pieces are subject to a sufficient amount of thermal energy. Measuring the temperature in the oven can be accomplished using any known temperature measuring device, for example, using a load thermocouple coupled to a temperature recorder.

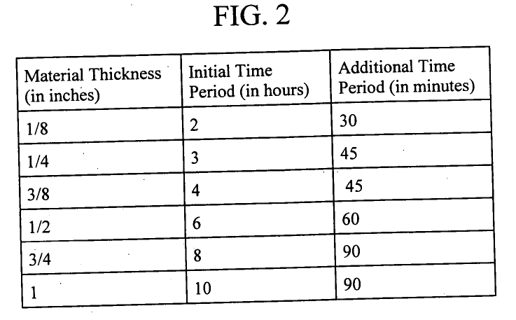

Referring to FIG. 2, column 1 shows the thickness of the pieces and column 2 shows the period of time for heating the pieces when the oven temperature is measured and controlled, in this case, to be at a set temperature of about 170° F. It can be seen that thicker pieces require more heating time.

When the temperature in the oven is not measured and controlled based on the measurement, the pieces must be heated for an additional period of time to ensure that they are subjected to sufficient thermal energy to eliminate the stressing of the cut and machined surfaces. This additional period of time is also dependent on the thickness of the pieces as shown in column 3 in FIG. 2.

After the pieces have been kept in the oven for a suitable period of time to subject them to sufficient thermal energy to eliminate the stressing (to make them resistant to alcohol-based chemicals) of the cut and machined surfaces, the determination of the duration of this suitable period of time being variable as discussed above, the pieces are removed from the oven, step 20, and cooled slowly, step 22. Preferably, the pieces are cooled in a draft-free area while being covered, e.g., with a blanket.

Instead of removing the pieces from the oven to cool, it is possible to turn the oven off and open the oven door, step 24. The pieces are then removed from the oven after having cooled, step 26. Other ways to slowly or gradually cool the pieces are also envisioned within the scope and spirit of the invention.

Thus, disclosed above, is a method for finishing acrylic pieces having cut and/or machined surfaces which subjects the pieces to a controlled amount of heat in order to eliminate the stress of the cut and/or machined surfaces while maintaining the form of the acrylic pieces.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A method for finishing an acrylic piece having cut and machined surfaces, comprising:
heating the acrylic piece;
maintaining the acrylic piece at a set temperature or within a set temperature range for a predetermined period of time dependent on a thickness of the piece; and
suspending the heating of the acrylic piece after the predetermined period of time, whereby after suspending the heating, the cut and machined surfaces of the acrylic piece are non-stressed.

2. The method of claim 1, further comprising controlling the heating of the acrylic piece at the set temperature or within the set temperature range.

3. The method of claim 2, wherein the temperature is controlled to maintain the temperature of the acrylic piece in a range from 110° F. less than a predetermined temperature to 10° F. more than the predetermined temperature.

4. The method of claim 2, wherein the step of controlling the heating comprises measuring a temperature in an enclosed environment in which the acrylic piece is placed and adjusting the temperature of the enclosed environment based on the measured temperature.

5. The method of claim 1, wherein the set temperature is about 170° F.

6. The method of claim 1, wherein the set temperature range is from about 160° F. to about 180° F.

7. The method of claim 1, wherein the heating of the acrylic piece occurs by placing the acrylic piece in an enclosed environment, and further comprising setting the predetermined period of time based on whether the temperature in the enclosed environment is measured.

8. The method of claim 7, wherein when the temperature in the enclosed environment is not measured, the step of setting the predetermined period of time comprises fixing an initial period of time for use if the temperature in the enclosed environment is maintained at the set temperature or within the set temperature range and adding an additional period of time to the initial period of time.

9. The method of claim 8, further comprising determining the additional period of time based on the thickness of the at least one piece.

10. The method of claim 1, further comprising the step of exposing all sides of the piece by removing from the piece, protective film or paper provided on one or more sides of the piece during manufacture of the piece.

11. The method of claim 1, further comprising cleaning the sides of the piece after the sides are exposed.

12. The method of claim 11, wherein the step of cleaning the sides of the piece comprises directing a stream of clean air at the piece.

13. The method of claim 1, further comprising the step of inserting the piece into an enclosed environment and placing the piece onto a rack and inserting the rack into the enclosed environment.

14. The method of claim 13, wherein the acrylic piece comprises a plurality of acrylic pieces, the step of placing the pieces onto the rack comprises arranging the pieces on the rack such that each piece is not in contact with any other piece.

15. The method of claim 13, wherein the enclosed environment is an oven.

16. The method of claim 13, wherein the enclosed environment is an electrically heated oven with forced air circulation.

17. The method of claim 13, further comprising:
heating the enclosed environment to heat the acrylic piece;
ceasing heating of the enclosed environment after the predetermined period of time;
exposing the enclosed environment to ambient atmosphere; and
allowing the piece to cool in the enclosed environment,
the piece being removed from the enclosed environment after having cooled to ambient temperature.

18. The method of claim 1, wherein the predetermined period of time is dependent on the thickness of the piece such that for the same temperature or temperature range, the predetermined period of time is greater for a thicker piece.

19. The method of claim 1, wherein the acrylic piece comprises a plurality of acrylic pieces, and further comprising the step of inserting the pieces into an enclosed environment, placing the pieces onto a plurality of racks such that each piece is not in contact with any other piece, and inserting the racks into the enclosed environment such that the racks and thus the pieces thereon are vertically spaced from one another.

20. The method of claim 1, wherein piece is removed from the enclosed environment while the temperature of the acrylic piece is above ambient temperature, further comprising allowing the piece to cool after removal from the enclosed environment.

21. The method of claim 1, wherein the heating of the acrylic piece occurs by thermal heating.

22. A product obtained by the process comprising:
cutting and machining an acrylic piece to a desired dimension and shape;
heating the acrylic piece;
maintaining the acrylic piece at a predetermined temperature or within a set temperature range for a predetermined period of time dependent upon the thickness of the acrylic piece;
suspending heating of the acrylic piece after the predetermined period of time, whereby after suspending the heating, the cut and machined surfaces of the acrylic piece are non-stressed.
